(19) United States
(12) Patent Application Publication
(10) Pub. No.: US 2025/0266636 A1
(43) Pub. Date: Aug. 21, 2025

(54) CONNECTOR AND CONNECTOR ASSEMBLY

(71) Applicant: SUMITOMO WIRING SYSTEMS, LTD., Mie (JP)

(72) Inventor: Tomokazu KASHIWADA, Mie (JP)

(21) Appl. No.: 19/051,382

(22) Filed: Feb. 12, 2025

(30) Foreign Application Priority Data
Feb. 20, 2024 (JP) 2024-023558

(51) Int. Cl. H01R 13/424; H01R 13/6581

(52) U.S. Cl. CPC H01R 13/424; H01R 13/6581; H01R 2201/26

(57) ABSTRACT

A female connector 31 includes a female terminal 33 having an insertion portion 33a into which a male terminal 23 is to be inserted, an insulating housing 34 that houses the female terminal 33, an insulating housing 34 that houses the female terminal 33, and a shield shell that covers the insulating housing 34. The insulating housing 34 includes a housing body 50 and a cover 60. The housing body 50 includes a first opening 51 to which the female terminal 33 is inserted and the second opening 52 separate from the first opening 51. The cover 60 is attached to the housing body 50 so as to cover the second opening 52. The cover 60 includes a first locking portion 63 that locks to the female terminal 33 to prevent the female terminal 33 from coming out from a first opening 51.

### CROSS-REFERENCE TO RELATED APPLICATIONS

This application is based on and claims priority from Japanese Patent Application No. 2024-023558, filed on Feb. 20, 2024, with the Japan Patent Office, the disclosure of which is incorporated herein in its entirety by reference.

### TECHNICAL FIELD

The present disclosure relates to a connector and a connector assembly.

### BACKGROUND

Conventionally, as a connector mounted in the vehicle, for example, a connector is known that is provided with a female terminal having an insertion portion into which a male terminal of a partner connector is to be inserted, an insulating housing that houses the female terminal, and a shield shell that covers the insulating housing (e.g., see JP 2018-055833 A). The female terminal housed in the insulating housing is prevented from coming out from the insulating housing by being locked by a flexible locking portion formed on the insulating housing. When attaching the female terminal to the insulating housing, the flexible locking portion comes into contact with the female terminal and bends so as to retract. Then, when the female terminal is inserted into a proper position, the flexible locking portion returns to the original position due to its elasticity, and thus the flexible locking portion is locked to the female terminal.

### SUMMARY

In the connector as described above, it is necessary to secure a space in which the flexible locking portion can move in the insulating housing, which is disadvantageous in terms of downsizing the insulating housing.

An object of the present disclosure is to provide a connector and a connector assembly that can be downsized.

A connector according to the present disclosure is a connector including: a female terminal having an insertion portion into which a male terminal of a partner connector is to be inserted; an insulating housing that houses the female terminal; and a shield shell that covers the insulating housing, and the insulating housing includes a housing body and a cover, the housing body includes a first opening into which the female terminal is inserted and a second opening separate from the first opening, the cover is attached to the housing body so as to cover the second opening, and the cover includes a first locking portion that locks to the female terminal to prevent the female terminal from coming out from the first opening.

With the connector and the connector assembly according to the present disclosure, downsizing can be achieved.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exploded perspective view of a connector assembly according to an embodiment.

FIG. 2 is an exploded perspective view of the connector assembly according to the embodiment.

FIG. 3 is an exploded side view of the connector assembly according to the embodiment.

FIG. 4 is an exploded perspective view of a female connector according to the embodiment.

FIG. 5 is an exploded perspective view of an insulating housing according to the embodiment.

FIG. 6 is a side view of the insulating housing according to the embodiment.

FIG. 7 is a cross-sectional view taken along line 7-7 in FIG. 6.

FIG. 8 is a cross-sectional view taken along line 8-8 in FIG. 6.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, aspects of the present disclosure will be listed and described.
[1] A connector according to the present disclosure includes: a female terminal having an insertion portion into which a male terminal of a partner connector is to be inserted; an insulating housing that houses the female terminal; and a shield shell that covers the insulating housing, and the insulating housing includes a housing body and a cover, the housing body includes a first opening into which the female terminal is inserted and a second opening separate from the first opening, the cover is attached to the housing body so as to cover the second opening, and the cover includes a first locking portion that locks to the female terminal to prevent the female terminal from coming out from the first opening.

According to this configuration, the first locking portion of the cover can prevent the female terminal from coming out from the insulating housing. Here, since the insulating housing includes two components, i.e., the housing body and the cover, it is not necessary to configure the first locking portion to be elastically bendable for attaching of the female terminal. That is, the first locking portion can be locked to the female terminal by inserting the female terminal into the housing body and then attaching the cover to the housing body. Therefore, it is not necessary to secure a space in which the first locking portion can move and be elastically bent, and as a result, the configuration is advantageous in downsizing the insulating housing.
[2] In the above [1], a configuration is also possible in which the female terminal is inserted into the first opening along a length direction of the female terminal, the female terminal has a lock portion, the cover includes the first locking portion and a second locking portion separate from the first locking portion, and the first locking portion and the second locking portion are locked to the lock portion on both sides of the lock portion in the length direction.

According to this configuration, the female terminal can be positioned in the length direction thereof by the first locking portion and the second locking portion of the cover.
[3] A connector assembly according to the present disclosure includes: a female connector which is the connector according to the above [1] or [2]; and a male connector which is the partner connector that is connected to the female connector.

According to this configuration, it is possible to achieve the same effects as the above-described connector.
[4] In the above [3], a configuration is also possible in which the male connector includes a connector housing fittable to the shield shell, and the male terminal that is held by the connector housing, the connector housing includes a touch prevention wall extending along the male terminal at least partially in a circumstantial direction around the male terminal, and in a state where the shield shell of the female connector and the connector housing of the male connector are fitted together and the male terminal is inserted into the insertion portion of the female terminal, the touch prevention wall is inserted into the insulating housing and located between the insertion portion and an inner surface of the insulating housing.

With this configuration, by the touch prevention wall located between the insertion portion of the female terminal and the inner surface of the insulating housing, it is possible to secure the creepage distance from the female terminal to the shield shell. As a result, the insulation performance of the connector assembly can be improved.

### Details of Embodiments of the Present Disclosure

Specific examples of a connector and a connector assembly according to the present disclosure will be described below with reference to the drawings. In the drawings, the configurations may be partially exaggerated or simplified for convenience in the description. Also, the dimensional ratios of various portions may differ among the drawings. The drawings show an X axis, a Y axis, and a Z axis that are orthogonal to each other. As used herein, a direction extending along the X axis is referred to as an X-axis direction, a direction extending along the Y axis is referred to as a Y-axis direction, and a direction extending along the Z axis is referred to as a Z-axis direction. The terms “parallel” and “orthogonal” in this specification include not only strictly parallel and orthogonal relationships, but also approximately parallel and orthogonal relationships to the extent that effects of the present embodiment are achieved. The term “tubular” as described herein includes not only a shape with a peripheral wall continuously formed around the entire circumference in a circumferential direction, but also a tubular shape formed by a combination of a plurality of components, and a tubular shape having a partially cut-out portion or the like in a circumferential direction thereof, such as a C-shape. Also, the “tubular” shape includes a circular shape, an elliptic shape, and a polygonal shape having pointed or rounded corners. The term “opposed” as used herein refers to surfaces or members that are located in front of each other, and includes not only a case where they are located fully in front of each other, but also a case where they are located partially in front of each other. In addition, “opposed” as used herein includes both a case where two portions are opposed with a portion other than the two portions interposed therebetween, and a case where two portions are opposed with nothing interposed therebetween. As used herein, the terms “first”, “second”, and the like are used to simply differentiate objects, and are not to be construed as ranking objects. It should be noted that the present invention is not limited to these examples but is indicated by the scope of the claims, and is intended to include all changes within the meaning and scope equivalent to the scope of the claims.

### (Connector Assembly 11)

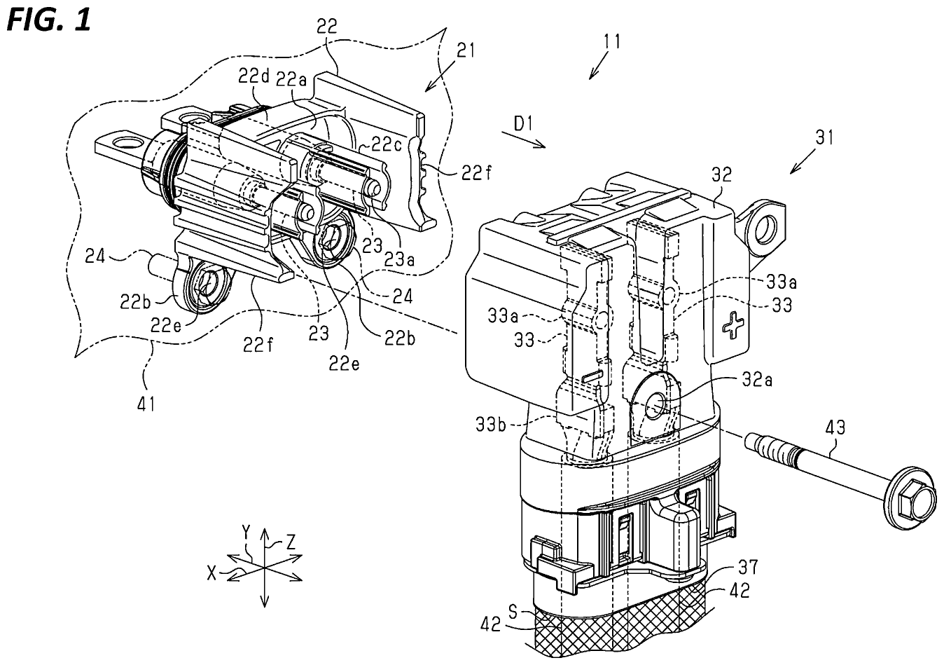

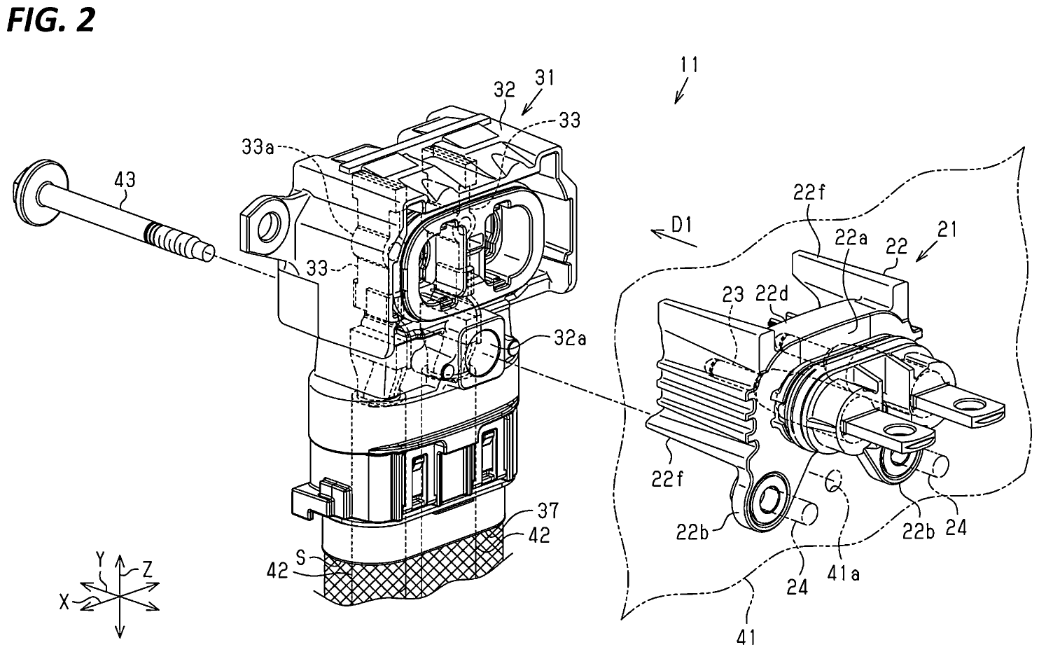

As shown in FIGS. 1 and 2, a connector assembly 11 includes a male connector 21, and a female connector 31 that is connectable to the male connector 21. The connector assembly 11 is configured to be provided in a vehicle. For example, the male connector 21 is to be fixed to a metal case 41 in the vehicle. For example, the female connector 31 is to be fixed to end portions of two wires 42.

### (Male Connector 21)

As shown in FIG. 1, the male connector 21 has a connector housing 22 and, for example, two male terminals 23 held by the connector housing 22. The connector housing 22 is formed by an insulating body such as a synthetic resin. The connector housing 22 is moved relative to a shield shell 32 (described later) constituting the female connector 31 along a fitting direction D1 extending along the Y axis and fitted to the shield shell 32.

The connector housing 22 includes a base portion 22a, a fixing portion 22b, the touch prevention walls 22c, a tube portion 22d, and a pair of guide walls 22f, for example.

The base portion 22a of the connector housing 22 is formed in a plate shape. The base portion 22a has a quadrangular shape elongated in the width direction as viewed in the Y-axis direction, for example, and the corners thereof are chamfered in arc shapes. For example, the two male terminals 23 are arranged in the X-axis direction and held by the base portion 22a. The male terminals 23 extend linearly along the fitting direction D1 extending along the Y axis. A cap 23a made of resin or rubber is fixed to a front end portion of each of the male terminals 23 in the fitting direction D1, for example.

A pair of fixing portions 22b of the connector housing 22 extend from, for example, a portion of the outer edge of the base portion 22a. Each of the fixing portions 22b has a through hole 22e extending through the fixing portion 22b in the Y-axis direction. The connector housing 22 is fixed to the metal case 41 using fixing bolts 24 configured to pass through the corresponding through holes 22e and be threadably engaged with female threads (not shown) provided in the metal case 41.

Touch prevention walls 22c are provided at the base portion 22a and protrude from the surroundings of the respective male terminals 23 in the fitting direction D1. The touch prevention walls 22c extend along the corresponding male terminal 23 in a portion in the circumferential direction around the male terminal 23. That is, the touch prevention walls 22c linearly extend in the fitting direction D1 along the Y axis. A pair of touch prevention walls 22c are provided around each of the male terminals 23, for example. The pair of touch prevention walls 22c are provided on both sides of each male terminal 23 in the X-axis direction. Each pair of touch prevention walls 22c partially cover the surroundings of the corresponding male terminal 23 while being slightly spaced apart from the male terminal 23. The position of the leading end of each male terminal 23 in the X-axis direction and the position of the leading end of each touch prevention wall 22c in the X-axis direction are set at the same position, for example. The distance from the corresponding male terminal 23, strength, and the like of each touch prevention wall 22c are set so as to satisfy the safety requirements against touch, as required by, for example, “JIS C 0920-2003”.

The tube portion 22d of the connector housing 22 has a tubular shape centered about an axis extending in parallel to the X axis. The tube portion 22d extends from, for example, the entire circumference of the outer edge of the base portion 22a along the fitting direction D1. The pair of guide walls 22f of the connector housing 22 are formed as one piece with the tube portion 22d. The two guide walls 22f are respectively provided on opposite sides of the tube portion 22d in the X-axis direction so as to be opposed to each other in the X-axis direction. The two guide walls 22f have shapes that are symmetrical to each other, for example. The male terminals 23 and the touch prevention walls 22c are provided between the two guide walls 22f in the X-axis direction. The guide walls 22f are inserted into the shield shell 32 of the female connector 31 to guide the fitting of the connector housing 22 to the shield shell 32.

### (Female Connector 31)

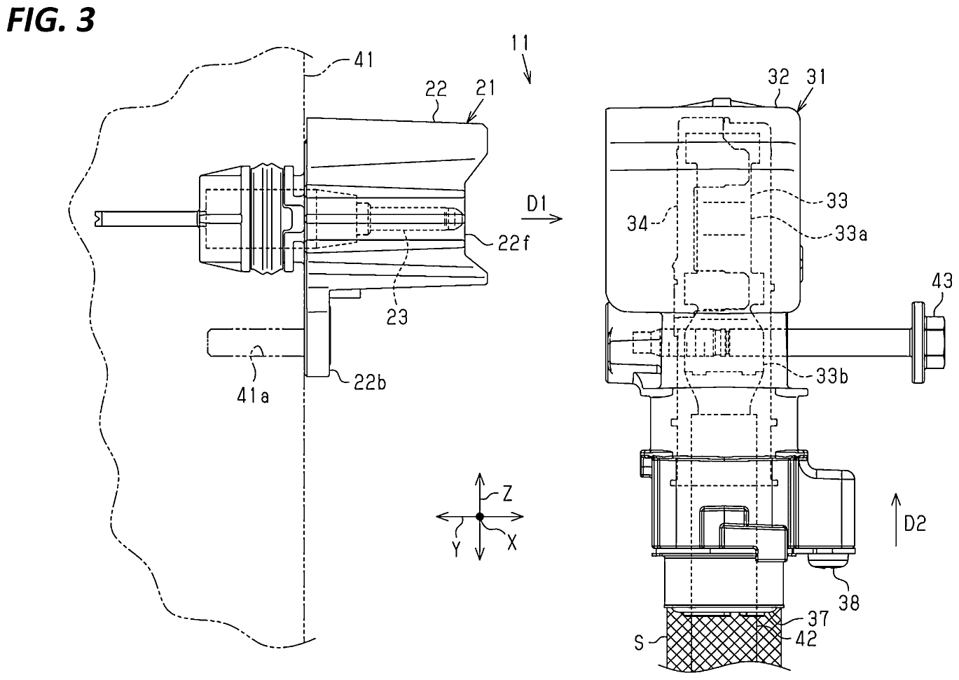

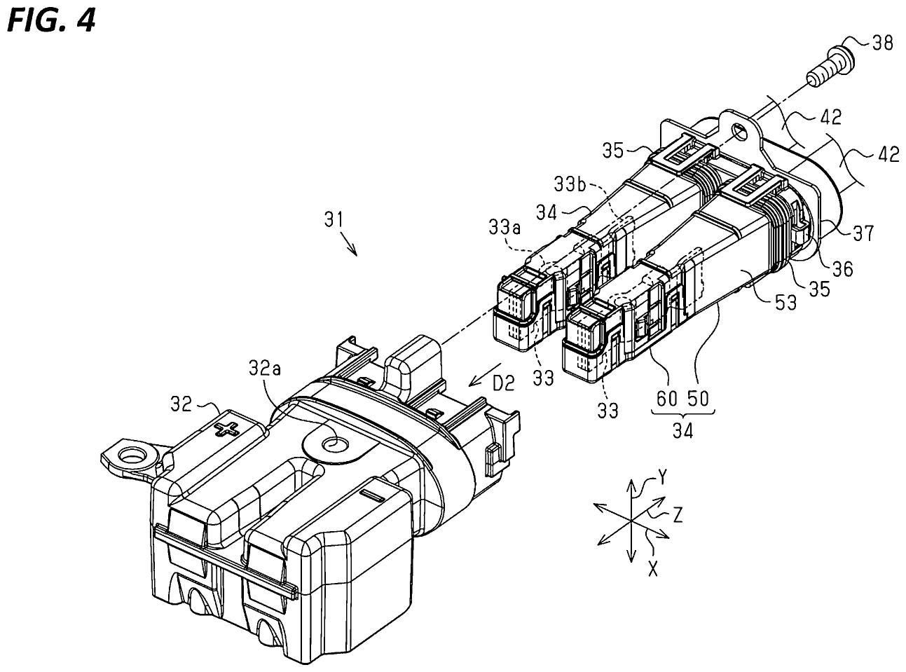

As shown in FIGS. 3 and 4, the female connector 31 includes the shield shell 32 made of metal, female terminals 33 located inside the shield shell 32, and insulating housings 34 that each houses the female terminal 33, for example. The shield shell 32 is attached to the connector housing 22 fixed to the metal case 41 in the X axis direction (specifically, the opposite direction to the fitting direction D1).

The shield shell 32 is, for example, a metal shell having an electromagnetic shielding function. The shield shell 32 is formed so as to cover the insulating housings 34. The shield shell 32 is formed in a shape that conforms to the shape of the insulating housings 34 such that the shield shell can house the insulating housings 34 substantially without a gap. The insulating housings 34 and the female terminals 33 housed therein are inserted into the shield shell 32 in the insertion direction D2 along the Z-axis. The insulating housings 34 are formed in a tubular shape so as to cover the female terminals 33.

The female terminals 33 extend along the Z-axis direction, and in the present embodiment, two female terminals 33, which correspond to the number of wires 42, are provided. The two female terminals 33 are provided side by side in the X-axis direction. The two insulating housings 34 for housing the female terminals 33 are provided corresponding to the number of the female terminals 33. That is, two insulating housings 34 are provided to house the two female terminals 33, respectively.

Each of the female terminals 33 includes an insertion portion 33a into which the corresponding male terminal 23 are inserted along the fitting direction D1, and a wire connecting portion 33b to which the corresponding wire 42 is connected. The wire connecting portion 33b is formed at one end portion in the Z-axis direction of each female terminal 33. The female terminals 33 have a shape extending from the corresponding insertion portion 33a toward both sides in the Z-axis direction. In a state where the male terminals 23 are respectively inserted into the insertion portions 33a of the female terminals 33, the portions in the female terminals 33 that extend on both sides in the Z-axis direction from the insertion portion 33a are also located between the pair of touch prevention walls 22c together with the insertion portion 33a. Although formed by bending a metal plate material, the female terminals 33 are schematically illustrated in the drawings without being illustrated in detail. Further, in the present embodiment, the wire connecting portions 33b and the wires 42 are resistance-welded, for example.

As shown in FIG. 3, the female connector 31 further includes rubber plugs 35, retainers 36, and a metal bracket 37.

Each rubber plug 35 is formed in a tubular shape and is interposed between the wire 42 and the shield shell 32. In this manner, the rubber plugs 35 prevent intrusion of liquid into the shield shell 32.

The retainers 36 are made of resin. The retainers 36 are locked to the shield shell 32, and prevents the rubber plugs 35 from coming out from the shield shell 32.

The metal bracket 37, to which a collective shield member S serving as a shield member covering the wires 42 is connected, is connected to the shield shell 32. Specifically, the shield member of the present embodiment is a tubular collective shield member S that collectively covers the plurality of wires 42. Also, the collective shield member S of the present embodiment is a braided member obtained by braiding conductive elemental wires made of a copper alloy, an aluminum alloy, or the like into a tubular shape. The entire circumference of the collective shield member S is connected to the metal bracket 37, and the metal bracket 37 is connected to the shield shell 32. The metal bracket 37 is fastened and fixed to the shield shell 32 with a screw 38.

The collective shield member S is electrically connected to the metal case 41 via the metal bracket 37, the shield shell 32, and a bolt 43, and is grounded. Therefore, the radiation of electromagnetic noise from the wires 42 and the female terminals 33 covered by the collective shield member S, the metal bracket 37, and the shield shell 32 is favorably suppressed.

As shown in FIG. 4, the shield shell 32 is provided with a fixing hole 32a extending through the shield shell 32 along the X-axis. The shield shell 32 is configured to be fixed to the metal case 41 by the bolt 43 that passes through the fixing hole 32a and is screwed into a female screw 41a provided in the metal case 41 (see FIG. 3).

### (Configuration of Insulating Housing 34)

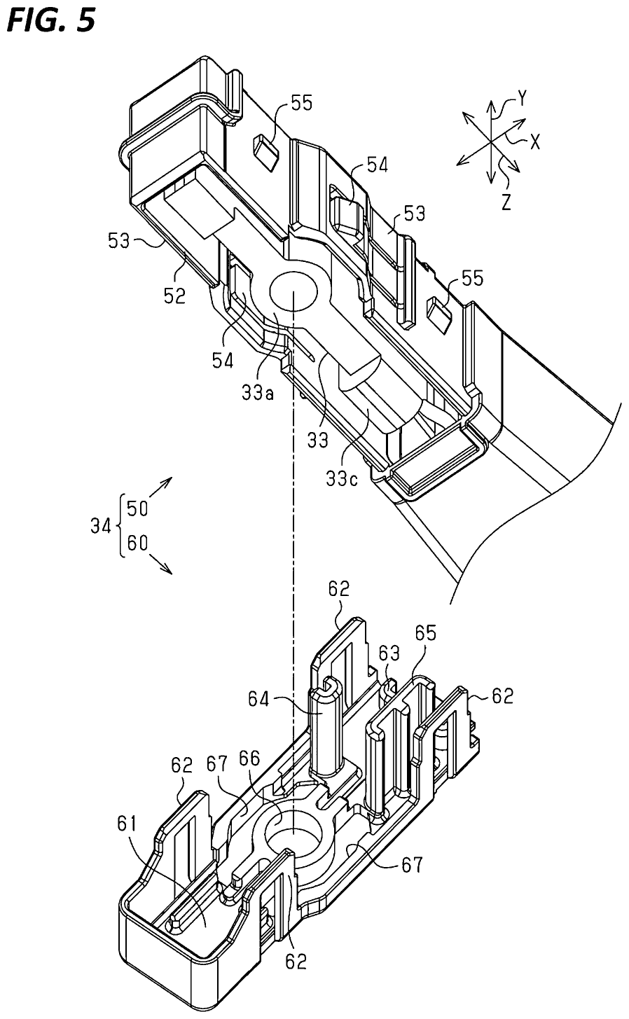

As shown in FIG. 5, each insulating housing 34 includes a housing body 50 and a cover 60 to be attached to the housing body 50.

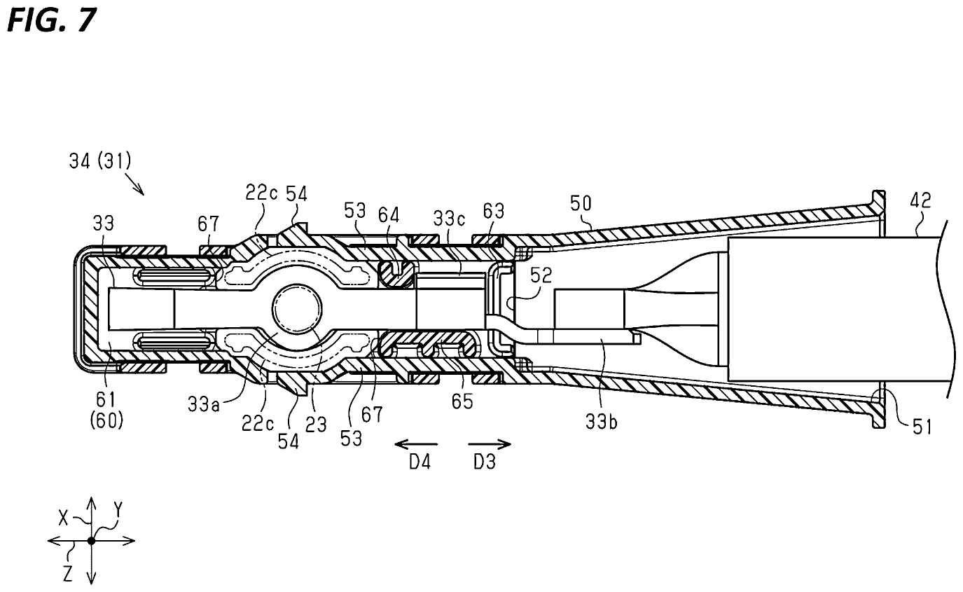

As shown in FIG. 7, the housing body 50 has an elongated shape along the length direction (Z-axis direction) of the female terminal 33. The housing body 50 has a first opening 51 into which the female terminal 33 is inserted along the Z-axis. The first opening 51 is provided in a base end portion of the housing body 50 in the Z-axis direction. The female terminal 33 is inserted into the housing body 50 through the first opening 51.

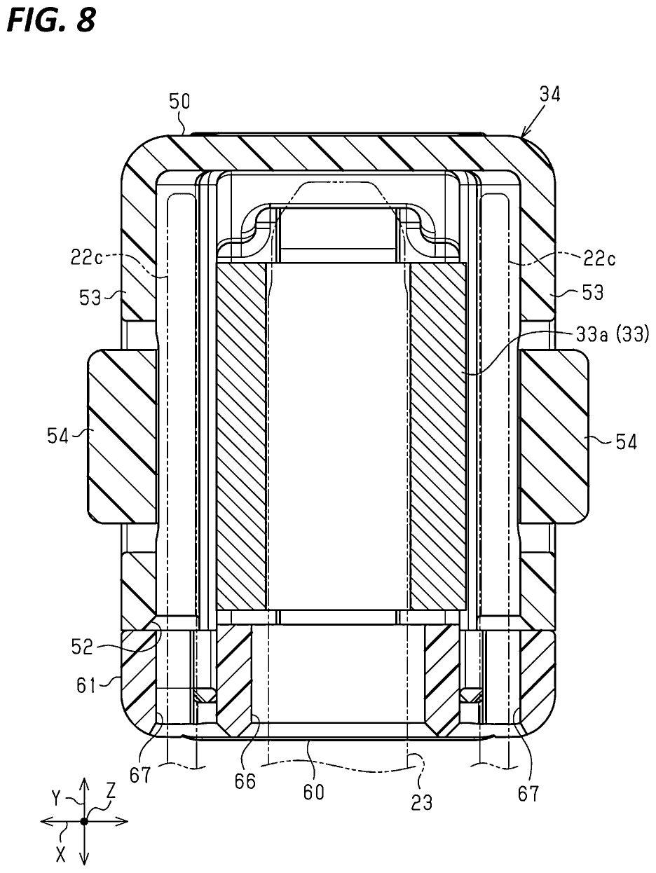

As shown in FIGS. 5 and 8, the housing body 50 has a second opening 52 that is different from the first opening 51. The second opening 52 is formed in a lower surface of the housing body 50 in the Y-axis direction. The second opening 52 is open in the Y-axis direction. Also, the housing body 50 has a pair of side walls 53 that oppose each other in the X-axis direction. The female terminal 33 is housed between the pair of side walls 53.

As shown in FIGS. 5, 6 and 7, the side walls 53 have elastic fixing pieces 54. The elastic fixing pieces 54 are respectively provided on the two side walls 53. Each elastic fixing piece 54 is formed on the corresponding side wall 53 so as to be bendable in the X-axis direction. The elastic fixing pieces 54 are locked to the inner surface of the shield shell 32 in the Z-axis direction. Thus, the insulating housing 34 is prevented from coming out from the shield shell 32.

Each side wall 53 has locking protrusions 55 protruding in the X-axis direction from the outer side surface of the side wall 53. A pair of locking protrusions 55 are provided on each of the side walls 53, for example.

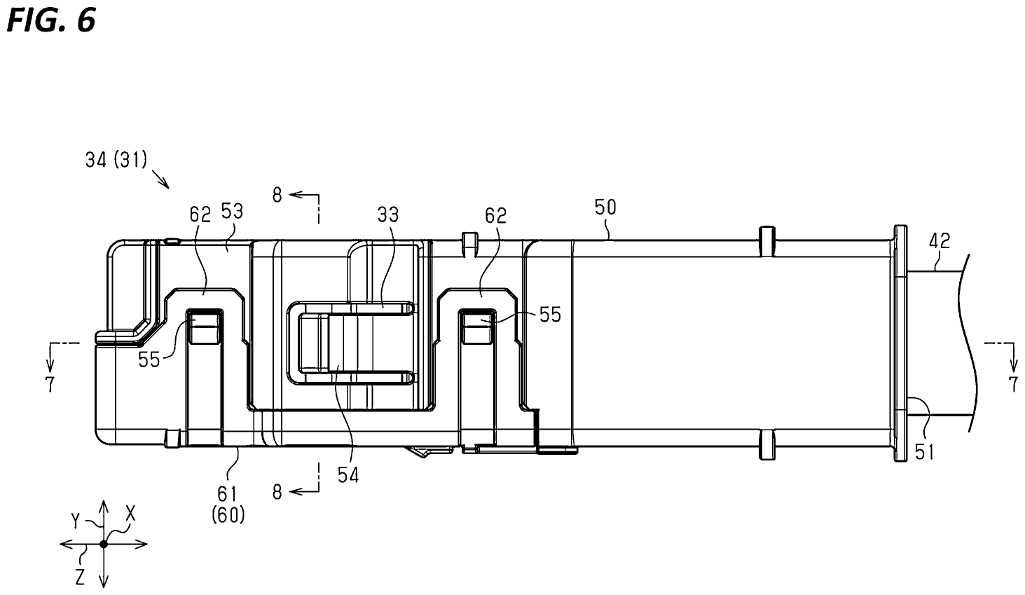

The cover 60 is attached to the housing body 50 so as to cover the second opening 52. As shown in FIGS. 5 and 6, the cover 60 includes a cover body 61 for covering the second opening 52 and lock portions 62 provided on the cover body 61. A pair of lock portions 62 are provided on both edges of the cover body 61 in the X-axis direction so as to correspond to the locking protrusions 55 of the housing body 50. The lock portions 62 are locked to the respective locking protrusion 55 in the Y-axis direction. In this manner, the cover 60 is fixed to the housing body 50.

As shown in FIGS. 5 and 7, the cover 60 includes a first locking portion 63, a second locking portion 64, and a support wall 65, which are provided on the cover body 61. The first locking portion 63, the second locking portion 64, and the support wall 65 protrude from the cover body 61 toward the inside of the housing body 50 along the Y-axis. Each of the first locking portions 63 and the second locking portions 64 are configured to be locked in the Z-axis direction with respect to a lock portion 33c provided in the female terminals 33. The lock portion 33c is disposed between the first locking portion 63 and the second locking portion 64 in the Z-axis direction. The first locking portion 63 is provided at a position closer to the first opening 51 than the second locking portion 64. The lock portion 33c is locked to the first locking portion 63 in a coming-out direction D3 (a direction toward the first opening 51) along the Z-axis. Further, the lock portion 33c is locked to the second locking portion 64 in a direction D4 that is an opposite direction to the coming-out direction D3. In this manner, the lock portion 33c is locked to the first locking portion 63 and the second locking portion 64, so that the female terminals 33 are positioned in the Z-axis direction. In a state where the cover 60 is not attached to the housing body 50, the insertion portion 33a and the lock portion 33c of each of the female terminals 33 are exposed through the second opening 52.

The support wall 65 of the cover 60 is provided so as to face the second locking portion 64 in the X-axis direction. The female terminal 33 is disposed so as to extend between the second locking portion 64 and the support wall 65. The second locking portion 64 and the support wall 65 position the female terminal 33 in the X-axis direction.

As shown in FIG. 8, each cover body 61 includes a terminal insertion hole 66 and a pair of wall insertion holes 67. The terminal insertion hole 66 and the wall insertion holes 67 extend through the cover body 61 in the Y-axis direction.

In a state where the shield shell 32 and the connector housing 22 are fitted to each other, the male terminals 23 of the male connector 21 are respectively inserted into the terminal insertion holes 66 along the Y-axis. That is, each male terminal 23 is inserted into the corresponding housing body 50 via the terminal insertion hole 66. Each male terminal 23 is inserted along the Y-axis into the insertion portion 33a of the corresponding female terminal 33 inside the corresponding housing body 50.

In a state where the shield shell 32 and the connector housing 22 are fitted to each other, the pair of touch prevention walls 22c of the male connector 21 are inserted into the pair of wall insertion holes 67 of the cover body 61 along the Y-axis. That is, the touch prevention walls 22c are inserted into the housing body 50 via the wall insertion holes 67. The touch prevention walls 22c are located between the insertion portion 33a of the female terminal 33 and the inner surface of the insulating housing 34. The touch prevention walls 22c are disposed between the insertion portion 33a and the inner surface of the insulating housing 34 in the X-axis direction, for example.

### (Operations of Embodiment)

The following describes operations of the present embodiment.

When attaching the female terminals 33 to the insulating housings 34, first, the female terminals 33 are inserted into the respective housing bodies 50 via the first openings 51. In this state, the insertion portions 33a and the lock portions 33c of the female terminals 33 are exposed through the second openings 52 of the housing body 50.

Thereafter, the covers 60 are attached to the second openings 52 of the housing bodies 50, respectively. At this time, each lock portion 33c of the female terminal 33 enters between the first locking portion 63 and the second locked portion 64 of the cover 60. As a result, each lock portion 33c becomes capable of being locked to the first locking portion 63 in the coming-out direction D3. Therefore, the first locking portion 63 can prevent the female terminal 33 from coming out from the first opening 51.

After the female terminals 33 are attached to the insulating housings 34, the insulating housings 34 are attached to the shield shell 32. The insulating housings 34 are fixed to the inner surface of the shield shell 32 by the elastic fixing pieces 54 of the housing body 50.

When the male connector 21 and the female connector 31 are fitted to each other, the male terminals 23 and the touch prevention walls 22c of the male connector 21 are inserted into the insulating housings 34. Each male terminal 23 is inserted into the insertion portion 33a of the corresponding female terminal 33, and electrically connected thereto.

In a state where each male terminal 23 is inserted into the insertion portion 33a of the corresponding female terminal 33, the touch prevention walls 22c of the male connector 21 are inserted into the insulating housing 34 of the female connector 31 and is located between the insertion portion 33a and the inner surface of the insulating housing 34. In this manner, the creepage distance from the female terminal 33 to the shield shell 32 can be secured. In particular, in the present embodiment, since the elastic fixing pieces 54 are formed on the side walls 53, gap extending through the side walls 53 are formed near the elastic fixing pieces 54. The touch prevention walls 22c cover the gap from the inner side of the housing body 50. And thus the creepage distance from the female terminals 33 to the shield shell 32 can be secured.

### (Effects of Present Embodiment)

The following describes effects of the present embodiment.
(1) Each insulating housing 34 for housing the female terminal 33 includes the housing body 50 and the cover 60. The housing body 50 includes the first opening 51 into which the female terminal 33 is to be inserted and the second opening 52 that is separate from the first opening 51. The cover 60 is attached to the housing body 50 so as to cover the second opening 52. The cover 60 includes the first locking portion 63 that locks to the female terminal 33 to prevent the female terminal 33 from coming out from the first opening 51. With this configuration, since the insulating housing 34 includes two components, namely, the housing body 50 and the cover 60, a configuration is no longer necessary in which the first locking portion 63 can be elastically bent for attachment of the female terminal 33. That is, after the female terminal 33 is inserted into the housing body 50, the cover 60 is attached to the housing body 50. In this manner, the first locking portion 63 can be locked to the female terminal 33. Accordingly, it is no longer necessary to ensure a space in which the first locking portion 63 can be elastically bent, and as a result, a configuration that is advantageous for downsizing the insulating housing 34 is realized.
(2) Each female terminal 33 is inserted into the first opening 51 along the length direction (Z axis direction) of the female terminal 33. The female terminal 33 includes the lock portion 33c. The cover 60 includes the first locking portion 63 and the second locking portion 64 that is separate from the first locking portion 63. The first locking portion 63 and the second locking portion 64 are locked to the lock portions 33c on both sides of the lock portion 33c in the length direction (Z axis direction) of the female terminal 33. With this configuration, the first locking portion 63 and the second locking portion 64 of the cover 60 make it possible to position the female terminal 33 in the length direction thereof.
(3) Each male connector 21 includes the connector housing 22 that is fittable to the shield shell 32 and the male terminal 23 held by the connector housing 22. The connector housing 22 includes the touch prevention walls 22c that extend along the male terminal 23 at least partially in the circumferential direction of the male terminal 23. In the state where the shield shell 32 is fitted to the connector housing 22 and the male terminals 23 are inserted into the insertion portions 33a of the corresponding female terminals 33, the touch prevention walls 22c are inserted into the insulating housings 34 and located between the insertion portion 33a and the inner surface of the insulating housing 34. With this configuration, due to the touch prevention walls 22c located between the insertion portion 33a of the female terminal 33 and the inner surface of the insulating housing 34, the creepage distance from the female terminal 33 to the shield shell 32 can be secured. As a result, the insulation performance of the connector assembly 11 can be improved.

### (Other Embodiments)

The present embodiment can be implemented with modifications such as the following. The present embodiment and the following variations can be implemented in combination with each other as long as no technical contradiction arises.
The second locking portion 64 and the support wall 65 can be omitted from the above-described cover 60.
In the above embodiment, the touch prevention walls 22c are inserted into each insulating housing 34, but the present disclosure is not limited thereto. The touch prevention walls 22c may be located outside of each insulating housing 34.
In the above-described embodiment, each male terminal 23 is inserted to the insertion portion 33a of the female terminal 33 in the Y-axis direction orthogonal to the length direction (Z-axis direction) of the corresponding female terminal 33, but the present disclosure is not limited thereto. For example, each male terminal 23 may be inserted into the insertion portion 33a in the length direction (Z-axis direction) of the corresponding female terminal 33. In this case, the touch prevention walls 22c of the male connectors 21 may be formed into a tubular shape surrounding the entirety of the male terminal 23.
The number of the male terminals 23 in each male connector 21 is not limited to two as in the above embodiments, and may be one or three or more. Also, in accordance with the change of the number of the male terminals 23, the number of the female terminals 33 and wires 42 may be changed as appropriate.
Although the above embodiment describes that the male connector 21 is fixed to the metal case 41, another configuration is possible such as that in which the male connector 21 is fixed to the vehicle panel.
The embodiments disclosed herein are illustrative in all respects, and the present invention is not limited to these illustrations. The scope of the present invention is indicated by the scope of the claims, and is intended to include all changes within the meaning and scope equivalent to the scope of the claims.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a female terminal having an insertion portion into which a male terminal of a partner connector is to be inserted;
an insulating housing that houses the female terminal; and
a shield shell that covers the insulating housing,
wherein the insulating housing includes a housing body and a cover,
the housing body includes a first opening into which the female terminal is inserted and a second opening separate from the first opening,
the cover is attached to the housing body so as to cover the second opening, and
the cover includes a first locking portion that locks to the female terminal to prevent the female terminal from coming out from the first opening.

2. The connector according to claim 1,
wherein the female terminal is inserted into the first opening along a length direction of the female terminal,
the female terminal has a lock portion,
the cover includes the first locking portion and a second locking portion separate from the first locking portion, and
the first locking portion and the second locking portion are locked to the lock portion on both sides of the lock portion in the length direction.

3. A connector assembly comprising:
a female connector which is the connector according to claim 1; and
a male connector which is the partner connector that is connected to the female connector.

4. The connector assembly according to claim 3,
wherein the male connector includes a connector housing fittable to the shield shell, and the male terminal that is held by the connector housing,
the connector housing includes a touch prevention wall extending along the male terminal at least partially in a circumstantial direction around the male terminal, and
in a state where the shield shell of the female connector and the connector housing of the male connector are fitted together and the male terminal is inserted into the insertion portion of the female terminal, the touch prevention wall is inserted into the insulating housing and located between the insertion portion and an inner surface of the insulating housing.
